(19) United States
(12) Patent Application Publication
(10) Pub. No.: US 2017/0331121 A1
(43) Pub. Date: Nov. 16, 2017

(54) POROUS POLYOLEFIN SUPPORTS FOR WATER VAPOR TRANSFER MEMBRANES FOR HUMIDIFIERS

(71) Applicant: GM GLOBAL TECHNOLOGY OPERATIONS LLC, DETROIT, MI (US)

(72) Inventors: TIMOTHY J. FULLER, PITTSFORD, NY (US); SHAWN M. CLAPHAM, CANANDAIGUA, NY (US); CRAIG S. GITTLEMAN, ROCHESTER, NY (US); CHAD A. DAMMAR, ROCHESTER, NY (US)

(21) Appl. No.: 15/150,981

(22) Filed: May 10, 2016

(51) Int. Cl. H01M 8/0239; H01M 8/2457; H01M 8/0258; H01M 8/04291

(52) U.S. Cl. CPC H01M 8/0239; H01M 8/04291; H01M 8/2457; H01M 8/0258

(57) ABSTRACT

A membrane humidifier assembly for fuel cell applications includes a first flow field plate adapted to facilitate flow of a first gas thereto, a second flow field plate adapted to facilitate flow of a second gas thereto, and a polymeric membrane disposed between the first flow field plate and second flow field plate. The polymeric membrane is adapted to permit transfer of water. In this regard, the polymeric membrane includes a porous polyolefin support and a perfluorosulfonic acid polymer layer disposed over the polyolefin support.

### TECHNICAL FIELD

In at least one embodiment, the present invention is related to fuel cell humidifiers having high water permeance.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ionically conductive polymer membrane to the cathode where they combine with oxygen to form water, which is discharged from the cell. The MEA is sandwiched between a pair of porous gas diffusion layers (“GDL”), which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cell stacks in order to provide high levels of electrical power.

The internal membranes used in fuel cells are typically maintained in a moist condition. This helps avoid damage to, or a shortened life of, the membranes, as well as to maintain the desired efficiency of operation. For example, lower water content of the membrane leads to a higher proton conduction resistance, thus resulting in a higher ohmic voltage loss. The humidification of the feed gases, in particular the cathode inlet, is desirable in order to maintain sufficient water content in the membrane, especially in the inlet region. Humidification in a fuel cell is discussed in commonly owned U.S. Pat. No. 7,036,466 issued May 2, 2006 to Goebel et al.; commonly owned U.S. Publication No. 2006/0029837 filed Feb. 9, 2006 to Sennoun et al.; and commonly owned U.S. Pat. No. 7,572,531 issued Aug. 11, 2009 to Forte, each of which is hereby incorporated herein by reference in its entirety.

To maintain a desired moisture level, an air humidifier is frequently used to humidify the air stream used in the fuel cell. The air humidifier normally consists of a round or box type air humidification module that is installed into a housing of the air humidifier. Examples of this type of air humidifier are shown and described in U.S. Pat. No. 7,156,379 issued Jan. 2, 2007 to Tanihara et al., and U.S. Pat. No. 6,471,195, each of which is hereby incorporated herein by reference in its entirety.

Membrane humidifiers have also been utilized to fulfill fuel cell humidification requirements. For the automotive fuel cell humidification application, such a membrane humidifier needs to be compact, exhibit low pressure drop, and have high performance characteristics.

Designing a membrane humidifier requires a balancing of mass transport resistance and pressure drop. To transport water from wet side to dry side through a membrane, water molecules must overcome some combination of the following resistances: convectional mass transport resistance in the wet and dry flow channels; diffusion transport resistance through the membrane; and diffusion transport resistance through the membrane support material. Compact and high performance membrane humidifiers typically require membrane materials with a high water transport rate (i.e. GPU in the range of 10,000-16,000). GPU or gas permeation unit is a partial pressure normalized flux where 1 GPU=10⁻⁶ cm³ (STP)/(cm² sec cm Hg). As a result, minimizing the transport resistance in the wet and dry flow channels and the membrane support material becomes a focus of design.

Accordingly, there is a need for improved materials and methodologies for humidifying fuel cells.

### SUMMARY

The present invention solves one or more problems of the prior art by providing in at least one embodiment, a membrane humidifier assembly for a fuel cell. The membrane humidifier includes a first flow field plate adapted to facilitate flow of a first gas thereto, a second flow field plate adapted to facilitate flow of a second gas thereto, and a polymeric membrane disposed between the first flow field plate and second flow field plate. The polymeric membrane is adapted to permit transfer of water. In this regard, the polymeric membrane includes a porous polyolefin support and a perfluorosulfonic acid polymer layer disposed over the polyolefin support.

In another embodiment, a fuel cell system incorporating the membrane humidifier assembly set forth above is provided. The fuel cell system includes a fuel cell stack having a cathode side and an anode side and a membrane humidifier assembly of the design set forth herein.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a schematic of a fuel cell system including a membrane humidifier assembly for humidifying a cathode inlet airflow to a fuel cell stack;

FIG. 2A is a schematic cross section of a membrane humidifier assembly perpendicular to the flow of gas to a first flow field plate;

FIG. 2B is a cross section of a membrane humidifier assembly with a peripheral sealing edge; and

FIG. 3 is a schematic cross section of a membrane humidifier assembly perpendicular to the cross section of FIG. 2A.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

In an embodiment, a membrane humidifier assembly for a fuel cell is provided. The membrane humidifier includes a first flow field plate adapted to facilitate flow of a first gas thereto, a second flow field plate adapted to facilitate flow of a second gas thereto, and a polymeric membrane disposed between the first flow field plate and second flow field plate. The polymeric membrane is adapted to permit transfer of water. In this regard, the polymeric membrane includes a porous polyolefin support and a perfluorosulfonic acid polymer layer disposed over the polyolefin support. Typically, the polyolefin support includes polyethylene and/or polypropylene layers. In a variation, the polyolefin support is a single polyolefin layer. In another variation, the polyolefin support includes multiple polyolefin layers. In a refinement, a commercial PFSA ionomer (e.g., IG151 from Asahi Glass) is used to coat commercially available, porous polyolefin supports in the preparation of leak-free, high permeance water vapor transport (WVT) membranes to be used in the membrane humidifier. These membranes are used to selectively feed humidified water vapor (from the cathode outlet) back to the cathode inlet of hydrogen/air fuel cells, while excluding the other exhaust gases. By so doing, water vapor generated by the fuel cell is recirculated to maintain the desired operational humidity in the fuel cell stack.

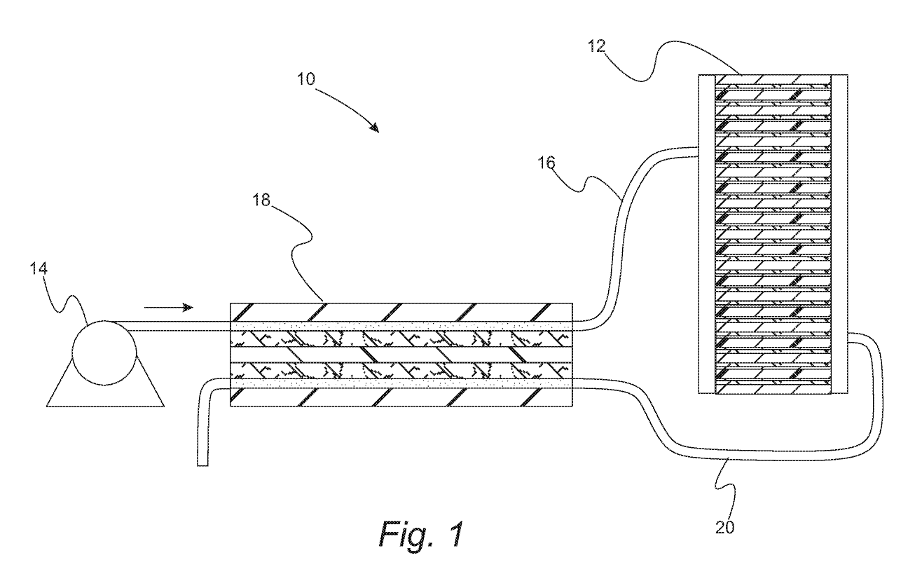

With reference to FIG. 1, a schematic of a fuel cell system incorporating a membrane humidifier assembly is provided. Fuel cell system 10 includes fuel cell stack 12. Compressor 14 provides a flow of air to the cathode side of the stack 12 on a cathode input line 16. The flow of air from the compressor 14 is sent through membrane humidifier assembly 18 to be humidified. A cathode exhaust gas is output from the stack 12 on a cathode output line 20. The cathode exhaust gas includes a considerable amount of water vapor and/or liquid water as a by-product of the electrochemical process in the fuel cell stack 12. As is well understood in the art, the cathode exhaust gas can be sent to membrane humidifier assembly 18 to provide the humidification for the cathode inlet air on the line 16.

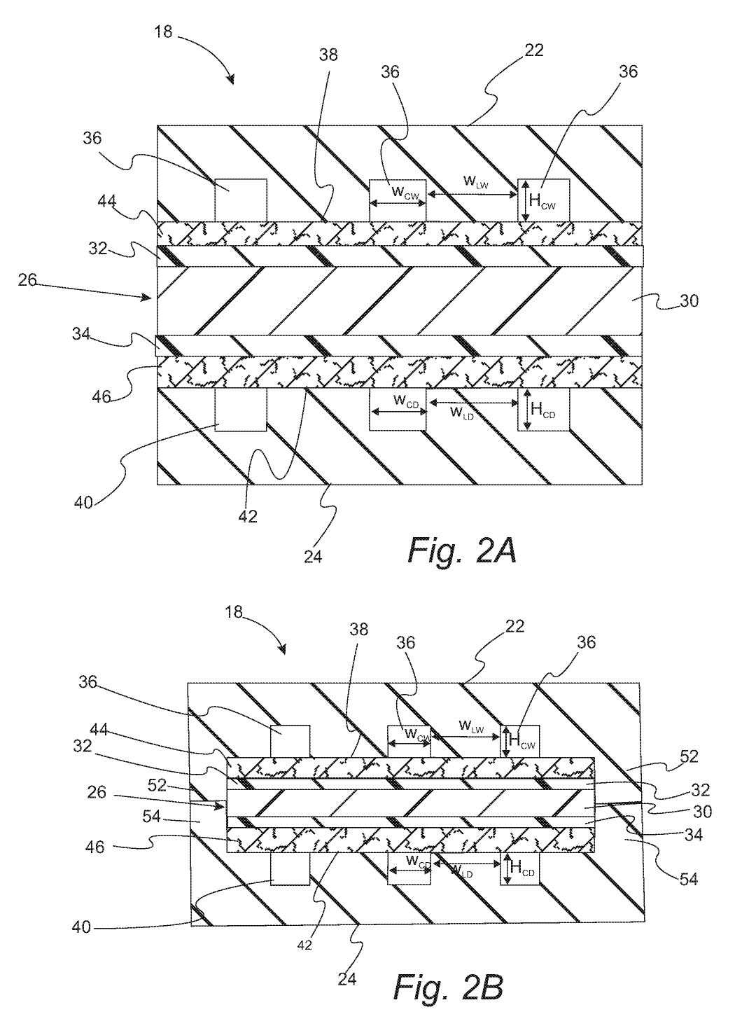

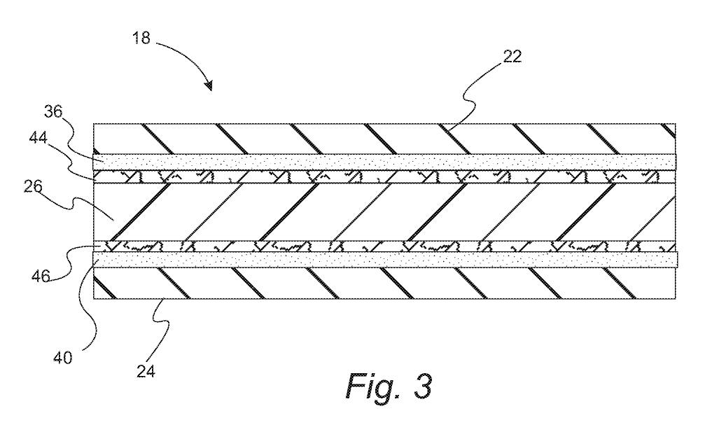

With reference to FIGS. 2A, 2B, and 3, schematic cross sections of a membrane humidifier assembly are provided. The membrane humidifier of this embodiment may be used in any application in which it is desirable to transfer water from a wet gas (e.g., air) to a dry gas (e.g., air) such as the fuel cell system of FIG. 1. FIG. 2A is a cross section of a membrane humidifier assembly perpendicular to the flow at which dry gas is introduced. FIG. 2B is a cross section of a membrane humidifier assembly with a peripheral sealing edge. FIG. 3 is a cross section of a membrane humidifier assembly perpendicular to the cross section of FIG. 2A. Membrane humidifier assembly 18 includes first flow field plate 22 adapted to facilitate flow of a first gas to membrane humidifier assembly 18. Membrane humidifier assembly 18 also includes second flow field plate 24 adapted to facilitate flow of a second gas to membrane humidifier assembly 18. In a refinement, first flow field plate 22 is a wet plate and second flow field plate 24 is a dry plate. Polymeric membrane 26 is disposed between the first flow field plate 22 and second flow field plate 24. In one variation, polymeric membrane 26 includes polyolefin support 30 and perfluorosulfonic acid polymer layers 32, 34 in FIGS. 2A and 2B disposed over the polyolefin support.

Polyolefin support 30 can include one or several layers (e.g., 2, 3, 4 or 5 layers). In some variations, the one or several layers independently consist of a single type of polyolefin. Suitable polyolefins include, but are not limited to, polyethylene, polypropylene, and combinations thereof. The polyolefin support can include polyolefin polymers having a weight average molecular weight from 1.5×10⁶ to 3.5×10⁶ and/or polyolefin polymers having a weight average molecular weight from 1.5×10³ to 8.0×10³. For examples, polyolefin support can includes a polyethylene layer, a polypropylene layer, and combinations thereof. In one useful refinement, polyolefin support 30 includes a polyethylene layer disposed between a first polypropylene layer and a second polypropylene layer. In a variation, the polyolefin support 30 has a Gurley Number from about 100 to about 800. As used herein, a Gurley Number is the time in seconds it takes for 100 cc of air to pass through one-square inch of membrane when a constant pressure of 4.88 inches of water is applied. In a refinement, the polyolefin support has a thickness from about 5 to 50 microns. In a further refinement, the perfluorosulfonic acid polymer layer has a thickness from about 0.5 to 25 microns.

In some variations, polyolefin support 30 has a porosity from about 25 to 95 percent or 25 to 75 percent prior to being coated with the perfluorosulfonic acid layer. In a refinement, polyolefin support 30 has a porosity from about 35 to 45 percent to more than 65 percent prior to being coated with the perfluorosulfonic acid layer. In a refinement of the present embodiment, polymeric membrane 26 has a permeance of equal to or greater than 10,000 GPU (permeance unit), and in particular, in the range of 10,000-25,000 GPU. In another refinement, polymeric membrane 26 has a permeance of equal to or greater than 15,000 GPU and, in particular, in the range of 15,000-25,000 GPU. Polymeric membrane 26 is adapted to permit transfer of water from the first gas to the second gas. For the embodiment shown and described herein, the membrane humidifier assembly 18 for a cathode side of the fuel cell is described. However, it is understood that the membrane humidifier assembly 18 can be used for an anode side of the fuel cell or otherwise as desired.

First flow field plate 22 includes a plurality of flow channels 36 formed therein. The channels 36 are adapted to convey a wet gas from the cathode of the fuel cell to an exhaust (not shown). In a refinement of the present embodiment, channels 36 are characterized by a width W_{CW} and a depth H_{CW}. A land 38 is formed between adjacent channels 36 in flow field plate 22. The land 38 includes a width W_{LW}. It should be appreciated that any conventional material can be used to form the first flow field plate 22. Examples of useful materials include, but are not limited to, steel, polymers, and composite materials, for example.

Second flow field plate 24 includes a plurality of flow channels 40 formed therein. The channels 40 are adapted to convey a dry gas from a source of gas (not shown) to the cathode of the fuel cell. As used herein, wet gas means a gas such as air and gas mixtures of O₂, N₂, H₂O, H_{z}, and combinations thereof, for example, that includes water vapor and/or liquid water therein at a level above that of the dry gas. Dry gas means a gas such as air and gas mixtures of O₂, N₂, H₂O, and H₂, and combinations thereof, for example, absent water vapor or including water vapor and/or liquid water therein at a level below that of the wet gas. It is understood that other gases or mixtures of gases can be used as desired. Channels 40 include a width W_{CD} and a depth H_{CD}. A land 42 is formed between adjacent channels 40 in second flow field plate 24. The land 42 includes a width W_{LD}. It should be appreciated that any conventional material can be used to form the dry plate 24 such as steel, polymers, and composite materials, for example.

In a refinement of the present embodiment, W_{CW} and W_{CD} are each independently from about 0.5 mm to about 5 mm. In another refinement, W_{LW} and W_{LD} are each independently from about 0.5 mm to about 5 mm. In still another refinement, H_{CW} and H_{CD} are each independently from about 0.1 to about 0.5 mm. In another refinement, H_{CW}, H_{CD} are each about 0.3 mm.

Still referring to FIGS. 2A, 2B, and 3 a diffusion medium or diffusion layer 44 is disposed adjacent the first flow field plate 22 and abuts the lands 38 thereof. Similarly, a diffusion medium or diffusion layer 46 is disposed adjacent the dry side plate 24 and abuts the lands 42 thereof. Selective polymer layer 32 is adhered to diffusion layer 44. In one refinement, selective polymer layer 32 is adhered to diffusion layer 44 by penetration of polymer layer 32 into diffusion layer 44. The diffusion media 44, 46 are formed from a resilient and gas permeable material such as carbon fabric, paper, polyester and glass fiber, for example. In a refinement of the present invention, diffusion media 44, 46 each independently have a thickness from about 0.05 to about 0.2 mm. In another variation, media 44, 46 each independently have a thickness from about 0.05 to about 0.15 mm. In still another variation, media 44, 46 each independently have porosity in the range of 50-95%. In yet another variation, media 44, 46 each independently have porosity from about 79 to about 90%. In another refinement, diffusion media 44, 46 are characterized by pores having a pore size from about 0.01 to about 100 micrometers. In another refinement, the pore size is from about 1 to about 50 micrometers.

In another variation as set forth in FIG. 2B, the first flow field plate 22 includes peripheral sealing section 52 and the second flow field plate 24 includes peripheral sealing section 54. In a refinement, sealing surface 52 completely surrounds flow field plate 22 and sealing surface 52 completely surrounds flow field plate 24.

Membrane humidifier assembly 18 advantageously allows the transfer of water from wet side channels 36 to the dry side channels 40. Although operation of the present invention is not restricted to any particular theory of operation, several transport modes are believed to be involved in the functioning of membrane humidifier assembly 18. Convection mass transport of water vapor occurs in the channels 36, 40 while diffusion transport occurs through the diffusion media 44, 46. Water vapor is also transported by diffusion through the polymeric membrane 26. Additionally, if a pressure differential exists between the channels 36 and channels 40, water is transferred through polymeric membrane 26 by hydraulic forces. Temperature differences between the channels 36 and channels 40 may also affect the transport of water. Finally, there is also an enthalpy exchange between the channels 36 of the wet side plate 22 and the channels 40 of the dry side plate 24.

During operation, the wet gas is caused to flow through the channels 36 formed in first flow field plate 22. The wet gas is received from a supply of wet gas. Any conventional means can be used to deliver the wet gas to the channels 36 such as a supply header in communication with the channels 36, for example. In the embodiment depicted in FIG. 1, the wet gas is supplied from an exhaust stream from fuel cell stack 12. The wet gas exits the channels 36 to the exhaust. The dry gas is caused to flow through the channels 40 formed in second flow field plate 24. Any conventional means can be used to deliver the dry gas to the channels 40 such as a supply header in communication with the channels 40. The dry gas then exits the channels 40. In the embodiment depicted in FIG. 1, the dry gas is supplied from compressor 14 (not shown).

In a variation of the present embodiment, the temperature of the wet gas is typically lower than the temperature of the dry gas. The temperature of the dry air from the compressor may be about 180 degrees Celsius, and the temperature of the wet air from the fuel cell exhaust may be about 80-95 degrees Celsius. If an air cooler (not shown) is used to cool the dry air supplied from the compressor, the temperature may be in the range of 95-105 degrees Celsius. It is understood that other temperature ranges can be used without departing from the scope and spirit of the invention. As a result of the temperature difference between the wet gas and the dry gas, the dry gas is also cooled during the humidification thereof. The cooling effect also increases the relative humidity of the newly humidified gas (the dry gas), thus minimizing a drying effect of the gas on components of the fuel cell.

During flow of the wet gas through the channels 36 and the flow of the dry gas through the channels 40, the wet gas is in cross flow with the dry gas. It is understood that a counter-flow of the gas streams can also be used to facilitate a transport of water vapor from wet gas stream to the dry gas stream. For a fuel cell humidification application, the water transfer effectiveness requirement is typically low. As a result, there is little expected performance difference between counter-flow and cross-flow design.

As set forth above, several variations of the membranes set forth above include a perfluorosulfonic acid (PFSA) polymer. Examples of useful PFSA polymers include a copolymer containing a polymerization unit based on a perfluorovinyl compound represented by:

CF₂═CF—(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene. Moreover, perfluorocyclobutane polymers with pendant sulfonic acid groups or perfluorosulfonic acid groups can be used as the ionomer component in the humidifier membranes having a porous polyolefin layer. In a refinement, the perfluorosulfonic acid layer is a perfluorocyclobutane polymer with pendant groups having the formula

—(CF₂CF₂)ₘ—O—(CF₂)_{q}SO₃H

where m represents an integer from 0 to 3, q represents an integer of from 1 to 12, and r represents 0 or 1. Suitable polymers for the perfluorosulfonic acid polymer having perfluorocyclobutyl moieties are disclosed in U.S. Pat. Pub. No. 2007/0099054, U.S. Pat. No. 7,897,691 issued Mar. 1, 2011; U.S. Pat. No. 7,897,692 issued Mar. 1, 2011; U.S. Pat. No. 7,888,433 issued Feb. 15, 2011, U.S. Pat. No. 7,897,693 issued Mar. 1, 2011; and U.S. Pat. No. 8,053,530 issued Nov. 8, 2011, the entire disclosures of which are hereby incorporated by reference.

The following examples illustrate the various embodiments of the present invention. Those skilled in the art will recognize many variations that are within the spirit of the present invention and scope of the claims.

Water Vapor Transport Membranes Made with Porous Polyolefin Support Films.

A perfluorosulfonic acid ionomer IG151 (from Asahi Glass) at 20 wt. % solids in 40:60 ethanol:water is diluted to 10 wt. % solids with ethanol. This 10 wt. % ionomer dispersion is coated with a 3-mil Bird applicator (P. E. Gardner) using an Erichsen coater onto a 1-mil, fluorinated ethylene-propylene (FEP)-coated polyimide film (KAPTON®120FN616, available from American Durafilm). A porous polyolefin film, used as a support layer and stretched on an embroidery frame, is laid on top of the wet draw-down layer of the IG151 ionomer. The solvent wicks into the porous polyolefin layer. After drying from 23 to 80° C. on a heated vacuum platen, the coated ionomer-polyolefin composite on the backer film is heated in an oven at 100° C. for 1 hour. After removal from the backer film, the ionomer layer is 5 microns thick and is partly imbibed into the porous polyolefin film support. The water vapor transfer (permeance) of the composite membrane is then measured using a 50 cm² membrane area, and straight flowfields with a similar geometry to that shown in U.S. Pat. No. 7,875,396, using counter flow, with a dry side flow of 11.5 slpm, 80° C., 183 kPaa, and a wet side flow of 10 slpm, 80° C., 160 kPaa exceeded (where kPaa refers to kilo-Pascal absolute). The beginning of test and end of test water vapor transfer in GPU (GPU is a partial pressure normalized flux where 1 GPU=10⁻⁶ cm³ (H₂O at STP)/(cm²×sec×cm Hg)) is summarized in the table below. In general, high permeance values are preferred with no leaks at beginning and end of test. Moreover, the absence of ion impurities as measured by water conductivity from water soaking tests is also preferred.

| | Film | IG151 | |
|---|---|---|---|
| | Support | Ionomer | |
| Polyolefin Film | Thickness | Thickness | Permeance, |
| Support | in microns | in microns | GPU |
| Entek Teklon | 20 | 5 | 17,700 |
| Celgard 2090 | 18 | 5 | 16,900 |
| Celgard 2500 | 27 | 5 | 15,700 |
| Celgard 2320 | 21 | 5 | 9,890 |
| Tonen E30TDP | 30 | 5 | 15,500 |
| Tonen 16 × 28 | 15 | 5 | 17,200 |

The use of different solvents in preparing the 10 wt % IG151 ionomer coating solution has also been investigated with different polyolefin support films. A 20 wt. % solids dispersion of IG151 is diluted to 10 wt. % solids with ethanol, n-propanol, and isopropanol, as indicated in the table below. The diluted ionomer dispersion in the various solvents was coated with a 3-mil Bird applicator as described above onto an FEP-Kapton-FEP backer film, and a porous polyolefin support film was laid on top of the wet-lay draw-down coating of the ionomer solution. After drying from 23 to 80° C. on a heated vacuum platen, the coated ionomer-polyolefin composite on the backer film is heated in an oven at 100° C. for 1 hour. After removal from the backer film, the ionomer layer is 5 microns thick and is partly imbibed into the porous polyolefin film support. The water vapor transfer (permeance) of the composite membrane is then measured using a 50 cm² membrane area. The results are summarized in the table below.

| | | | | Leak | Leak |
|---|---|---|---|---|---|
| | | | | Rate at | Rate at |
| | | | | Beginning | End of |
| Polyolefin Film | | | Permeance | of Test | Test |
| Support | Ionomer | Solvent | (GPU) | (sccm) | (sccm) |
| Celgard 2320 | IG151 | Ethanol | 9,900 | 0 | 0 |
| Entek | IG151 | n-Propanol | 10,500 | 0 | 0 |
| K162KJ32 | | | | | |
| Entek | IG151 | n-Propanol | 12,000 | 0 | 0 |
| K1650T33 | | | | | |
| Entek | IG151 | Isopropanol | 13,000 | 0 | 0 |
| K162KJ32 | | | | | |
| Tonen E30TDP | IG151 | Ethanol | 15,500 | 0 | 0 |
| Celgard 2500 | IG151 | Ethanol | 15,700 | 0 | 0 |
| Entek | IG151 | n-Propanol | 16,000 | 0 | 0 |
| PR540-03 | | | | | |
| Silica | | | | | |
| Celgard 2090 | IG151 | Ethanol | 16,900 | 42 | Not |
| | | | | | Done |
| Tonen 16 × 28 | IG151 | Ethanol | 17,200 | 0 | 0 |
| Entek Gray | IG151 | Ethanol | 17,700 | 0 | 0 |

The membranes in the table are listed in order of increasing water permeance, with higher permeance being preferred. With regards to the leaching out of ionic impurities in a 6-week, water soaking test, the porous polyolefin supports are listed in order of increasing water conductivity: Tonen E30TDP<Tonen 16×28<Celgard 2500<Celgard 2320<Entek Gray. The high permeance and low impurity levels of Tonen 16×28 are preferred. The Entek Gray support has the highest conductivity value and the highest undesired contamination in the leachant water in the water soak test. The Entek support with silica (PR540-03) appears to have better water permeance than those without, with the exception of the Entek Gray material, which has carbon black colorant and other unspecified additives. The colorant in Entek Gray is useful for identifying coating defects formed in the preparation of the WVT membranes. Entek is developing waterproof, breathable textiles using these porous polyolefin materials. Celgard 2090 has an open fishnet structure which results in high permeance but an unacceptably high beginning of life leak rate. Tonen has recently been acquired by Toray, and new, improved porous polyolefin materials are anticipated.

Water Vapor Transport of PFCB Membranes Made with Entek Gray.

A perfluorocyclobutane polymer (PFCB polymer TCT1215, Tetramer Technologies, L.L.C.) is a 90,000-molecular weight, multi-segmented block polymer, with anion exchange capacity of 1.88 milliequivalents of H⁺ per gram. TCT1215 is made of segments of about 16,000-molecular weight oligomeric biphenyl perfluorocyclobutane with pendant tetrafluoro-(2-(tetrafluoro-2-ethoxy)ethane sulfonic acid groups and segments of hexafluoroisopropylidene-bis trifluorovinyl ether. The PFCB polymer TCT1215 (1 gram) and Kynar Flex 2751 (0.11 g, Arkema) in N,N-dimethylacetamide (22 g) is coated with a 3-mil Bird applicator (P. E. Gardner) using an Erichsen coater onto a 1-mil, fluorinated ethylene-propylene (FEP)-coated polyimide film (KAPTON®120FN616, available from American Durafilm). A porous polyolefin film (Entek Gray), used as a support layer and stretched on an embroidery frame, is laid on top of the wet draw-down layer of the TCT1215-Kynar Flex 2751 ionomer blend. The solvent wicks into the porous polyolefin layer. After drying from 23 to 80° C. on a heated vacuum platen, the coated ionomer-polyolefin composite on the backer film is heated in an oven at 100° C. for 1 hour. After removal from the backer film, the ionomer layer is 5 microns thick and is partly imbibed into the porous polyolefin film support. The water vapor transfer (permeance) of the composite membrane is then measured using a 50 cm² membrane area, and straight flowfields with a similar geometry to that shown in U.S. Pat. No. 7,875,396, using counter flow, with a dry side flow of 11.5 slpm, 80° C., 183 kPaa, and a wet side flow of 10 slpm, 80° C., 160 kPa exceeded. The beginning of test of test water vapor transfer in GPU (GPU is a partial pressure normalized flux where 1 GPU=10⁻⁶ cm³ (H₂O at STP)/(cm²×sec×cm Hg)) is 15,500, and after 41 hours, is 17,700, with no leaks.

A water vapor transfer membrane that is fully imbibed with ionomer requires pretreating the Entek Gray film as follows. TCT1215 (0.15 g) in isopropanol (15 g) is draw-bar coated using a 3-mil Bird applicator onto a 1-mil, fluorinated ethylene-propylene (FEP)-coated polyimide film (KAPTON®120FN616, available from American Durafilm). Entek Gray, used as a support layer and stretched on an embroidery frame, is laid on top of the wet draw-down layer of TCT1215 in isopropanol. The porous polyolefin absorbs the ionomer and is then air dried. The Entek Gray film still stretched on the frame is then removed from the Kapton® 120FN616 backer film. A PFCB polymer TCT1215 (1 gram) and Kynar Flex 2751 (0.11 g, Arkema) in N,N-dimethylacetamide (22 g) is coated with a 3-mil Bird applicator (P. E. Gardner) using an Erichsen coater onto a 1-mil, fluorinated ethylene-propylene (FEP)-coated polyimide film (KAPTON®120FN616, available from American Durafilm). The treated Entek Gray film on the embroidery frame is then placed on top of the wet draw down layer of TCT1215 ionomer-Kynar Flex 2751 blend. The ionomer solution imbibes into the Entek Gray. Using a 3-mil Bird applicator with shims of Entek Gray and 1-mil Mylar tape, another layer of TCT1215 (0.15 g) in isopropanol (15 g) is draw-bar coated on top of the treated Entek Gray film imbibed with ionomer. The film is then dried from room temperature to 80° C. on the Erichsen coater platen. After removal from the frame, the membrane is dried to 90° C. in an oven for 1 hour. The initial water permeace of the Entek Gray membrane fully imbibed with TCT1215 (and 10 wt. % Kynar Flex 2751) is 9,000 GPU and after 41 hours is 11,000 GPU, with no leaks.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A membrane humidifier assembly for a fuel cell comprising:
a first flow field plate adapted to facilitate flow of a first gas thereto;
a second flow field plate adapted to facilitate flow of a second gas thereto; and
a polymeric membrane disposed between the first flow field plate and second flow field plate, the polymeric membrane adapted to permit transfer of water, the polymeric membrane comprising a porous polyolefin support and a perfluorosulfonic acid polymer layer disposed over the polyolefin support.

2. The membrane humidifier assembly of claim 1 wherein the perfluorosulfonic acid polymer layer is a copolymer formed from a polymerization unit having formula 1:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

3. The membrane humidifier assembly of claim 1 wherein the polymeric membrane has a permeance of greater than 6000 GPU.

4. The membrane humidifier assembly of claim 1 wherein the perfluorosulfonic acid polymer layer has a thickness from about 0.5 to 25 microns.

5. The membrane humidifier assembly of claim 1 wherein the polyolefin support has a thickness from about 5 to 50 microns.

6. The membrane humidifier assembly of claim 1 wherein the first flow field plate and the second flow field plate each independently include a peripheral sealing section.

7. The membrane humidifier assembly of claim 1 wherein the polyolefin support has a porosity from about 25 to 95 percent prior to being coated with the perfluorosulfonic acid polymer layer.

8. The membrane humidifier assembly of claim 1 wherein the polyolefin support has a Gurley Number from about 100 to about 800 prior to being coated with the perfluorosulfonic acid polymer layer.

9. The membrane humidifier assembly of claim 1 wherein the polyolefin support includes a layer selected from the group consisting of a polyethylene layer, a polypropylene layer, and combinations thereof.

10. The membrane humidifier assembly of claim 1 wherein the polyolefin support includes a polyethylene layer disposed between a first polypropylene layer and a second polypropylene layer.

11. The membrane humidifier assembly of claim 1 wherein the polyolefin support includes polyolefin polymers having a weight average molecular weight from 1.5×10⁶ to 3.5×10⁶ and/or weight average molecular weight from 1.5×10³ to 8.0×10³.

12. The membrane humidifier assembly of claim 1 wherein the perfluorosulfonic acid polymer layer is a perfluorocyclobutane polymer with pendant sulfonic acid groups.

13. The membrane humidifier assembly of claim 1 wherein the perfluorosulfonic acid polymer layer is a perfluorocyclobutane polymer with pendant groups having formula
—(CF₂CF₂)ₘ—O—(CF₂)_{q}SO₃H
wherein m is an integer from 0 to 3, q represents an integer of from 1 to 12, and r represents 0 or 1.

14. A fuel cell system comprising:
a fuel cell stack having a cathode side and an anode side;
a membrane humidifier assembly comprising:
a first flow field plate adapted to receive a first gas from the cathode side of the fuel cell stack;
a second flow field plate adapted to facilitate flow of a second gas thereto; and
a polymeric membrane disposed between the first flow field plate and second flow field plate, the polymeric membrane having a permeance of greater than 6000 GPU, the polymeric membrane comprising a porous polyolefin support and a perfluorosulfonic acid polymer layer disposed over the polyolefin support.

15. The fuel cell system of claim 14 wherein the perfluorosulfonic acid polymer layer is a copolymer formed from a polymerization unit having formula 1:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

16. The fuel cell system of claim 14 wherein the perfluorosulfonic acid polymer layer has a thickness from about 0.5 to 10 microns and the polyolefin support has a thickness from about 5 to 50 microns.

17. The fuel cell system of claim 14 wherein the polyolefin support has a porosity from about 25 to 75 percent.

18. The fuel cell system of claim 14 wherein the polyolefin support includes a layer selected from the group consisting of a polyethylene layer, a polypropylene layer, and combinations thereof.

19. The fuel cell system of claim 14 wherein the polyolefin support includes a polyethylene layer disposed between a first polypropylene layer and a second polypropylene layer.

20. The fuel cell system of claim 14 wherein the polyolefin support includes polyolefin polymers having a weight average molecular weight from 1.5×10⁶ to 3.5×10⁶ and/or polyolefin polymers having a weight average molecular weight from 1.5×10³ to 8.0×10³.
